(19) United States
(12) Patent Application Publication
(10) Pub. No.: US 2009/0290189 A1
(43) Pub. Date: Nov. 26, 2009

(54) Electronic document managing apparatus

(75) Inventors: Tetsuya Izu, Kawasaki (JP); Masahiko Takenaka, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/320,662

(22) Filed: Jan. 30, 2009

(30) Foreign Application Priority Data
May 22, 2008 (JP) 2008-134222

(51) Int. Cl. G06F 3/12; H04L 9/00

(52) U.S. Cl. 358/1.15; 726/1

(57) ABSTRACT

An integrator acquires an electronic document and revised documents revised by different revisers (administrative department, accounting department) in parallel, and makes reference to the electronic document to judge whether each partial document is not disclosed in each revised document with respect to each sub-document in the electronic document. When each sub-document is not disclosed in at least one of the revised documents, whether each sub-document is to be disclosed is determined in regard to each sub-document based on a policy P that specifies disclosure/nondisclosure of each sub-document divided from the electronic document, and a revised document obtained by integrating the revised documents is created based on a determination result.

### CROSS REFERENCE TO RELATED APPLICATIONS

This application is based upon and claims the benefit of priority from the prior Japanese Patent Application No. 2008-134222, filed on May 22, 2008, the entire contents of which are incorporated herein by reference.

### FIELD

The embodiments discussed herein are related to an electronic document management apparatus.

### BACKGROUND

As a technology that guarantees authenticity of an electronic document, a technology using an electronic signature has been conventionally provided. This electronic signature technology is a technology that gives an electronic signature with respect to each electronic document to authenticate a creator of the electronic document and judge validity of the electronic document, thereby guaranteeing authenticity of the electronic document. According to this electronic signature technology, falsification by an unauthorized user can be prevented.

There is also known a technology that guarantees authenticity of an electronic document by giving a signature to sub-document in a set consisting of sub-documents constituting the electronic document, or data obtained by combining each sub-document with information that specifies a relationship between structures of each sub-document and the electronic document, or to data obtained by calculating a hash value for each sub-document and combining the calculated hash values (see, e.g., Japanese Patent Application Laid-open No. 2005-051734).

There is known a system having a structure that a transactor for post-processing sequentially receives electronic mails asking for processing, e.g., deliberation or authorization of an electronic document along a workflow by using a server and a client terminal connected through a network. The transactor who receives the electronic mails sequentially accesses a file of the electronic document through the network to advance predetermined processing, thereby performing business processing (see, e.g., Japanese Patent Application Laid-open No. 2003-141315).

However, according to the conventional technology, in order to guarantee integrity of a revised electronic document, a sub-document subjected to revision such as deletion or electronic blackout cannot be restored to an original state. Therefore, even if a sub-document should be disclosed for, e.g., a legal reason, when revision such as deletion or electronic blackout has already been performed to the sub-document, there is a problem that the revision cannot be canceled.

Considering this problem, one countermeasure is to provide beforehand a sub-document with an attribute of prohibition of electronic blackout or deletion. However, in some cases, it is preferable for revisers to have different authorities. For example, one reviser is allowed to black out a document, but another reviser is prohibited from blacking out a document. When electronic blackout is completely prohibited, the authority of a reviser who should be allowed for electronic blackout is usurped, and there is a problem that users' convenience is degraded. When a plurality of revisers revises an electronic document one after another, a reviser whose turn comes faster has a stronger authority. Therefore, when a reviser performs revision that is beyond his/her authority, there is a problem that subsequent revisers cannot cancel such revision.

On the other hand, performing revision operations in parallel eliminates the problem of authority deviation, but electronic documents revised by revisers have to be integrated eventually. However, when different revisions are performed (or no revision is performed) to one sub-document, there is a problem that determining which revision has higher priority is difficult.

### SUMMARY

Accordingly to an aspect of the invention, a computer-readable recording medium storing a program causes a computer to perform: storing a policy that specifies a disclosure/nondisclosure status of a constituent element divided from an electronic document; acquiring the electronic document and a plurality of revised documents subjected to revision processing of determining nondisclosure of the constituent element in the electronic document concerning each of different revisers; judging, referring to the electronic document, whether the constituent element is not disclosed in each revised document according to the constituent element in the electronic document; determining whether the constituent element is to be disclosed based on the policy when the constituent element is determined not to be disclosed in at least one revised document; revising the constituent element in the electronic document based on a result of the determining; and outputting the revised electronic document.

The objectand advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is an explanatory diagram depicting problems in the conventional technologies;

FIG. 2 is another exemplary diagram depicting problems in the conventional technologies;

FIG. 3 is another exemplary diagram depicting problems in the conventional technologies;

FIG. 4 is an explanatory diagram of an outline of an embodiment;

FIG. 5 is a block diagram of an electronic document management apparatus according to an embodiment;

FIG. 6 is a block diagram of a functional structure of an electronic document managing apparatus;

FIG. 7 is a flowchart of an example of an electronic document management processing procedure;

FIG. 8 is a block diagram of a system structure of the electronic document managing system;

FIG. 9 is an explanatory diagram of an outline of the electronic signature technology;

FIG. 10 is an explanatory diagram of an outline of the revision processing;

FIG. 11 is an explanatory diagram of contents of the electronic document management DB;

FIG. 12 is an explanatory diagram of a specific example of an electronic document;

FIG. 13 is an explanatory diagram of a specific example of a policy table;

FIG. 14 is an explanatory diagram of a specific example of a transmission destination list;

FIG. 15 is an explanatory diagram of an outline of electronic document management processing in the electronic document verifying apparatus 804;

FIG. 16 is a flowchart of an electronic document management processing procedure of the electronic document verifying apparatus 804;

FIG. 17 is a flowchart of a specific processing procedure of the verification processing; and

FIG. 18 is a flowchart of a specific processing procedure of the determination processing.

### DESCRIPTION OF EMBODIMENT(S)

Preferred embodiments of the present invention will be explained with reference to the accompanying drawings.

In an electronic document management program, a recording medium recording this program, an electronic document managing apparatus, and an electronic document managing method, determining disclosure/nondisclosure of constituent elements in an electronic document according to a given policy enables automatically creating an integrated document obtained by integrating a plurality of revised documents subjected to revision processes of the electronic document by different revisers in parallel.

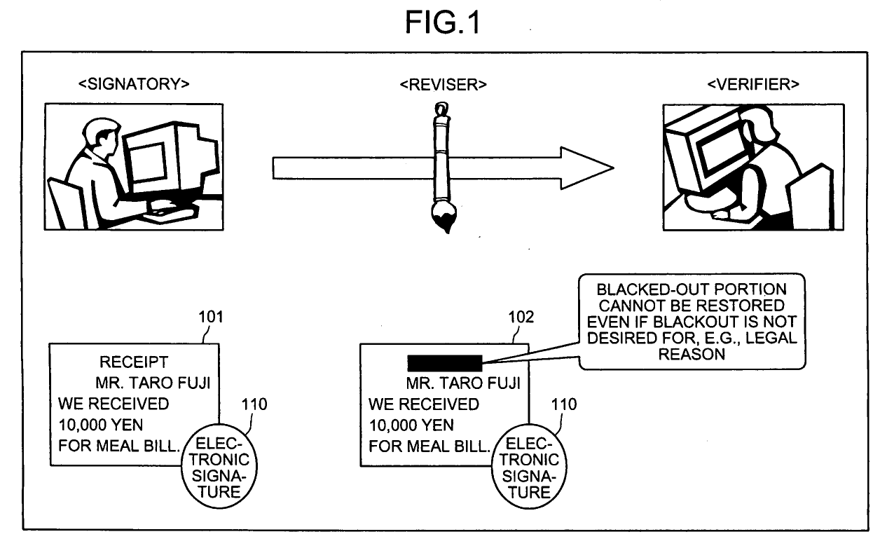

First, problems in conventional technologies are explained. FIGS. 1 to 3 are explanatory diagrams of problems in the conventional technologies. FIGS. 1 to 3 depict a series of flow until authenticity of a revised electronic document is verified. As depicted in FIG. 1, a signatory first sets an electronic signature 110 to an electronic document 101. The signatory is, e.g., a creator of the electronic document 101.

A reviser sanitizes a sub-document (“RECEIPT” in this example) in the electronic document 101 having the electronic signature 110 set thereto, thereby creating a revised document 102. In this case, a verifier can confirm whether contents of a disclosed portion in the revised document 102 are not altered.

However, to guarantee integrity of the revised document 102, the sanitized sub-document (“RECEIPT”) cannot be restored to an original state. Therefore, even if a blacked-out portion has contents that should be disclosed for, e.g., a legal reason, there is a problem that the blacked-out portion cannot be restored.

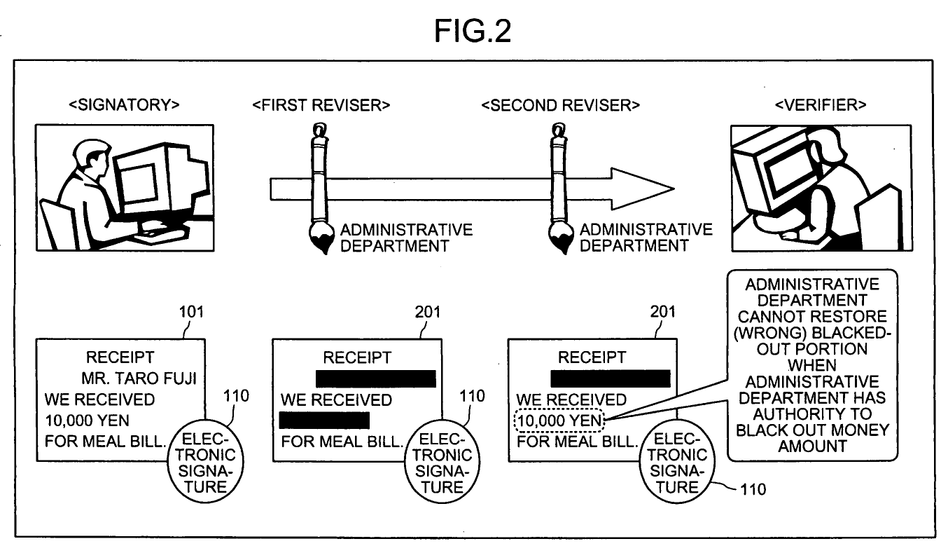

As depicted in FIG. 2, a first reviser (administrative department) sanitizes sub-documents (blacking out “MR. TARO FUJI” and “10,000 YEN” in this example) in the electronic document 101 having the electronic signature 110 set thereto, thereby creating a revised document 201. In this case, there is a problem that a second reviser (accounting department) cannot restore the electronic blackout performed by the first reviser (administrative department) even if the second reviser has authority to black out a money section. That is, since a reviser whose turn comes faster has stronger authority, when a reviser sanitizes a partial document beyond his/her authority, a blacked-out portion cannot be restored thereafter.

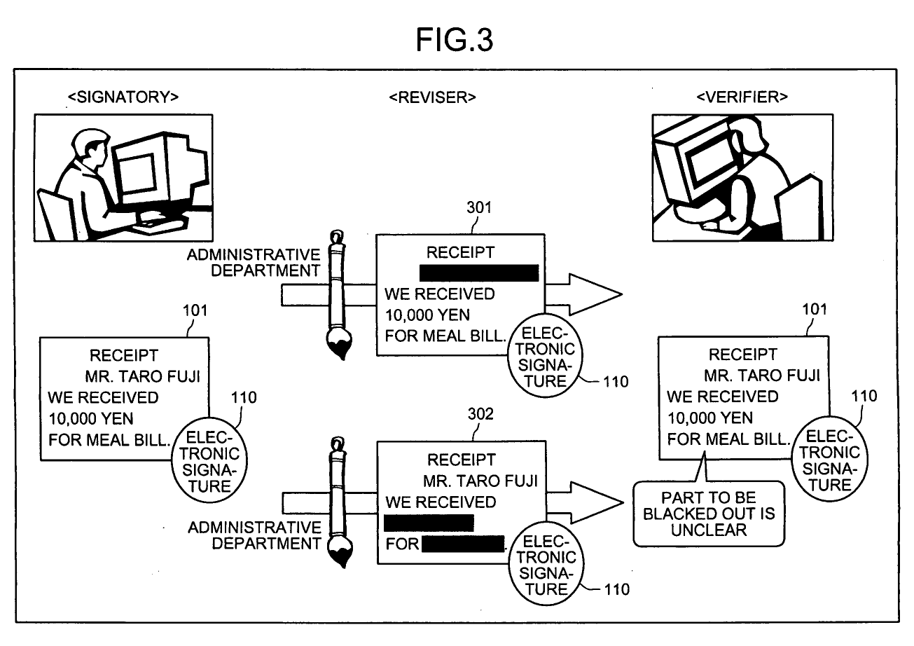

In FIG. 3, a plurality of revisers (administrative department, accounting department) revises in parallel the electronic document 101 having the electronic signature 110 set thereto. Specifically, the administrative department blacks out “MR. TARO FUJI” in the electronic document 101 to create a revised document 301. The accounting department blacks out “MEAL BILL” and “10,000 YEN” in the electronic document 101 to create a revised document 302.

In this case, although the problem caused due to authority deviation depicted in FIG. 2 can be eliminated, the revised documents 301 and 302 revised by the revisers in parallel must be eventually integrated. However, when revised positions or revised contents are not identical, there is a problem that determining which revision should have higher priority is difficult.

For example, although “MR. TARO FUJI” in the electronic document 101 is blacked out in the revised document 301, it is disclosed in the revised document 302. In such a case, a verifier requires a complicated operation, e.g., determining whether “MR. TARO FUJI” should be blacked out, comparing authorities of the respective revisers.

Thus, this embodiment proposes a technique of appropriately integrating the revised documents 301 and 302 by determining disclosure/nondisclosure of sub-documents in the electronic document 101 according to a given policy without requiring the above-explained complicated operation. An outline of this embodiment will now be explained hereinafter.

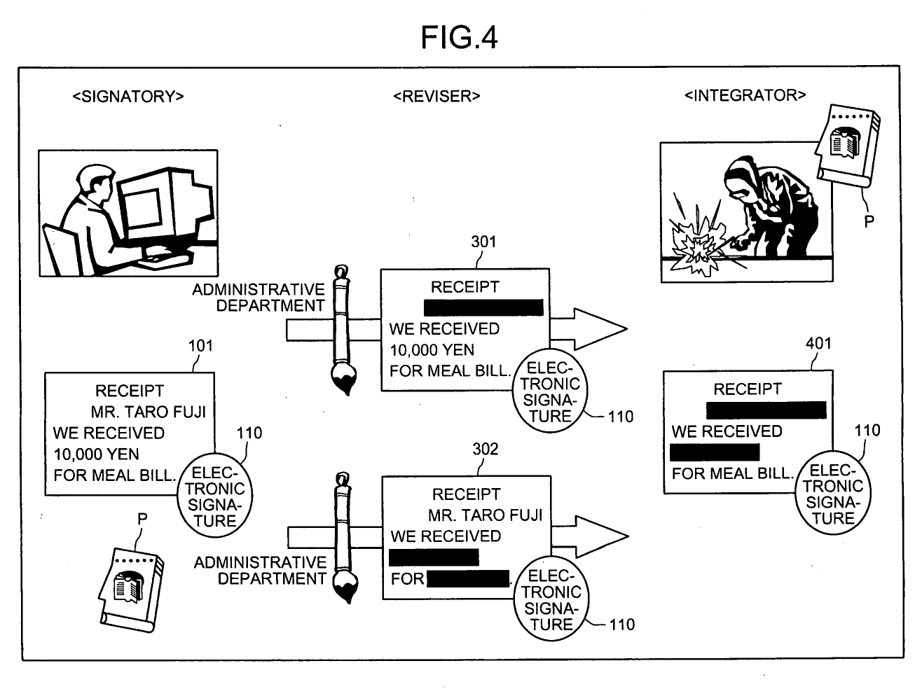

FIG. 4 is an explanatory diagram of an outline of this embodiment. As depicted in FIG. 4, a signatory first sets an electronic signature 110 to an electronic document 101. Further, a policy P that specifies disclosure/nondisclosure of each sub-document is created with respect to each sub-document of the electronic document 101. Different revisers (administrative department, accounting department) revise in parallel the electronic document 101 having the electronic signature 110 set thereto.

An integrator judges whether contents of disclosed parts in revised documents 301 and 302 have been altered. When the contents have not been altered, disclosure/nondisclosure of each sub-document in the electronic document 101 is determined based on the policy P, and a revised document 401 obtained by integrating the revised documents 301 and 302 is created based on a result of the determination.

As explained above, in this embodiment, the revised document 401 obtained by appropriately integrating the revised documents 301 and 302 subjected to revision processing in parallel by the different revisers (administrative department, accounting department) is automatically created by determining disclosure/nondisclosure of each sub-document in the electronic document 101 according to the given policy P.

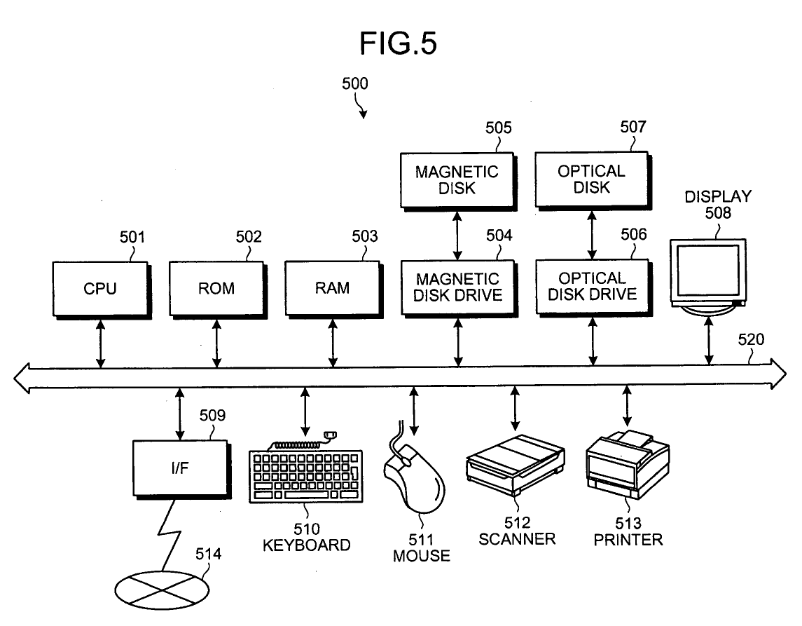

FIG. 5 is a block diagram of an electronic document management apparatus according to an embodiment. As depicted in FIG. 5, the electronic document management apparatus 500 includes a central processing unit (CPU) 501, a read-only memory (ROM) 502, a random access memory (RAM) 503, a magnetic disk 505, an optical disc drive 506, an optical disc 507, a display 508, an interface (I/F) 509, a keyboard 510, a mouse 511, a scanner 512, and a printer 513, connected to one another by way of a bus 520.

The CPU 501 governs overall control of the electronic document management apparatus 500. The ROM 502 stores therein programs such as a boot program. The RAM 503 is used as a work area of the CPU 501. The magnetic disk drive 504, under the control of the CPU 501, controls reading/writing of data from or to the magnetic disk 505. The magnetic disk 505 stores therein the data written under control of the magnetic disk drive 504.

The optical disc drive 506, under the control of the CPU 501, controls reading/writing of data from or to the optical disc 507. The optical disc 507 stores therein the data written under control of the optical disc drive 506, the data being read by a computer.

The display 508 displays a cursor, an icon, a tool box, and data such as document, image, and function information. The display 508 may be, for example, a cathode ray tube (CRT), a thin-film-transistor (TFT) liquid display, or a plasma display.

The I/F 509 is connected to a network 514 such as a local area network (LAN), a wide area network (WAN), or the Internet through a telecommunication line and is connected to other devices by way of the network 514. The I/F 509 manages the network 514 and an internal interface, and controls the input and output of data from or to external devices. The I/F 509 may be, for example, a modem or a LAN adapter.

The keyboard 510 is equipped with keys for the input of characters, numerals, and various instructions, and data is entered through the keyboard 510. The keyboard 510 may be a touch-panel input pad or a numeric keypad. The mouse 511 performs cursor movement, range selection, and movement, size change, etc., of a window. The mouse 511 may be a trackball or a joystick provided the trackball or joystick has similar functions as a pointing device.

The scanner 512 optically reads an image and takes in the image data into the electronic document management apparatus 500. The scanner 512 may have an optical character recognition (OCR) function as well. The printer 513 prints image data and document data. The printer 513 may be, for example, a laser printer or an ink jet printer.

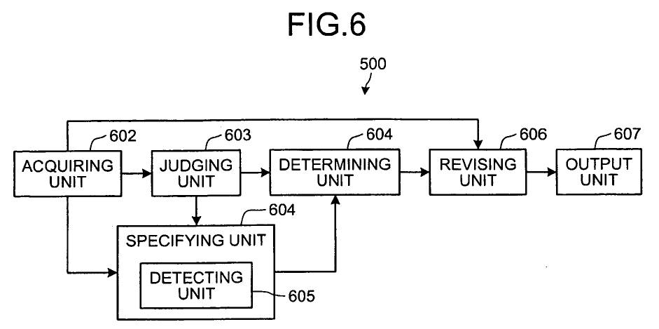

FIG. 6 is a block diagram of a functional structure of an electronic document managing apparatus. As depicted in FIG. 6, an electronic document managing apparatus 500 includes an acquiring unit 601, a judging unit 602, a determining unit 603, a specifying unit 604, a detecting unit 605, a revising unit 606, and an output unit 607.

Specifically, functions serving as a control unit (the acquiring unit 601 to the output unit 607) are realized by causing the CPU 501 to execute a program stored in a storage region, e.g., the ROM 502, the RAM 503, the magnetic disk 505, or the optical disc 507 or by the I/F 509 depicted in FIG. 5. In regard to each function provided at a connection destination indicated by each arrow in FIG. 6, output data from a function as a connection source is read from the storage region, and a program concerning the function at the destination of an arrow is executed by the CPU 501.

The acquiring unit 601 has a function of acquiring an electronic document M and a plurality of revised documents R subjected to revision processing of determining nondisclosure of arbitrary sub-documents in the electronic document M by different revisers. In this example, the electronic document M is a generic term of documents processed in a computer and corresponds to electronic data created by using, e.g., a document production application.

The electronic document M is, e.g., ledger sheets or slips, or personal information such as an electronic grade report or an electronic family register ledger. This electronic document M is divided into arbitrary constituent elements (e.g., sentences or words). The constituent element is referred to as a “sub-document” including at least one word.

An identifier (e.g., a later-explained “document ID”) that identifies the electronic document M is given to the electronic document M. An identifier (e.g., a later-explained “sub-document ID”) that identifies each sub-document is given to each sub-document in the electronic document M. Giving the document ID and the sub-document ID in this manner enables recognizing the electronic document M and each sub-document.

An electronic signature is set to the electronic document M. In this example, the electronic signature is signature information that is given to the electronic document to authenticate validity of the electronic document M. That is, the electronic document is used to prove a genuine creator of the electronic document M and validity (non-alteration) of the electronic document M like a physical signature such as a personal seal. An electronic signature technology for the electronic document M will be explained later.

Each revised document R is a revised electronic document subjected to deletion processing or blacking-out processing intended to conceal an arbitrary sub-document in the electronic document M. A personal electronic signature of a reviser may be set to the revised document R. Setting the personal electronic signature of a reviser in this manner enables recognizing the reviser of each revised document R.

The acquiring unit 601 also has a function of acquiring a policy that specifies disclosure/nondisclosure of each sub-document divided from the electronic document M. The policy is created by, e.g., a creator of the electronic document M or a signatory of an electronic signature set to the electronic document M. The policy can uniquely determine disclosure/nondisclosure of each sub-document. Revision contents (e.g., blackout, deletion, prohibition of blackout, prohibition of deletion, and others) of sub-documents may be specified.

Contents of the policy are, e.g., forcible disclosure, forcible nondisclosure, granting a specific reviser alone an authority of revision, giving priority to revision by a specific reviser, and determining nondisclosure of a sub-document when a percentage of revisers who decide nondisclosure of the sub-document in the whole revisers is at least equal to a specific percentage.

The policy is written in a language that is recognized by a computer, and cannot be edited by persons other than a creator thereof. It is to be noted that the electronic document M, the revised document R, and the policy may be directly input to the electronic document managing apparatus 500, or may be acquired from an external computer device.

The judging unit 602 has a function of judging whether a sub-document of the electronic document M is not disclosed in each revised document R acquired by the acquiring unit 601 by making reference to the electronic document M obtained by the acquiring unit 601. Specifically, for example, the judging unit 602 judges whether each sub-document in the electronic document M is not disclosed by specifying an attribute (deletion, blackout) of a sub-document in the revised document R corresponding to the sub-document.

The determining unit 603 has a function of determining whether each sub-document in the electronic document M is to be disclosed based on the policy acquired by the acquiring unit 601. Specifically, the determining unit 603 determines whether each sub-document is to be disclosed according to a result from the specifying unit 604 and the judging unit 602.

Determination processing by the determining unit 603 will now be explained. The specifying unit 604 first specifies a policy concerning a sub-document. When the specifying unit 604 specifies a policy of compulsory disclosure of the sub-document, the determining unit 603 determines that the sub-document is to be disclosed. When the specifying unit 604 specifies a policy of compulsory nondisclosure of the sub-document, the determining unit 603 determines that the sub-document is not to be disclosed.

When the judging unit 602 determines a status of a sub-document to be nondisclosure and the specifying unit 604 specifies a policy of giving priority to a specific reviser, the detecting unit 605 detects a disclosure/nondisclosure status of a sub-document in the revised document R revised by the specific reviser from among a plurality of revised documents R. Specifically, for example, the detecting unit 605 can recognize the specific reviser from an electronic signature set to each revised document R and detect disclosure/nondisclosure of a sub-document in the revised document R revised by the specific reviser.

The determining unit 603 determines whether a sub-document is to be disclosed based on a disclosure/nondisclosure status of the sub-document detected by the detecting unit 605. Specifically, when the sub-document in the revised document R by the specific reviser is disclosed, the sub-document is determined to be disclosed. On the other hand, when the sub-document is not disclosed, the sub-document is determined not to be disclosed.

When the judging unit 602 determines a status of a sub-document to be nondisclosure and the specifying unit 604 specifies a policy that nondisclosure of the sub-document is determined when a percentage of revisers who assign the nondisclosure status to the sub-document at least equal to a given percentage, the detecting unit 605 detects a percentage of the revised documents R whose sub-document is not to be disclosed.

Specifically, for example, the above-explained percentage can be detected by dividing the number of the revised documents R whose sub-documents is not to be disclosed by a total number of the revised documents R acquired by the acquiring unit 601. When the percentage detected by the detecting unit 605 is at least equal to a given percentage, the determining unit 603 determines that the sub-document is not disclosed. As the specific percentage, various percentages, e.g., 100%, 50%, 30%, or others are specified.

The revising unit 606 has a function of revising each sub-document in the electronic document M based on a determination result from the determining unit 603. When a sub-document is determined not to be disclosed, the revising unit 606 revises the sub-document in the electronic document M (e.g., blackout, deletion) not to disclose the sub-document. On the other hand, when the sub-document is determined to be disclosed, the sub-document in the electronic document M is not revised.

The output unit 607 has a function of outputting the revised electronic document M revised by the revising unit 606. Output formats are, for example, displaying on a display 508, printing output to a printer 513, and transmission to an external computer device through the I/F 509. The output unit 607 may output the document to a storage region, e.g., the RAM 503, the magnetic disk 505, or the optical disc 507.

Although the acquiring unit 601 acquires the revised documents R obtained by revising the electronic document M in parallel by revisers, the embodiment is not restricted thereto. For example, the acquiring unit 601 may acquire the revised document R obtained by revising the electronic document M in series by the revisers.

In this case, with reference to the electronic document M, the judging unit 602 judges whether each sub-document in the revised document R is not to be disclosed. When the judging unit 602 determines that a sub-document is not disclosed, the determining unit 603 determines whether the sub-document is to be disclosed based on the policy and a reviser who assigned a nondisclosure status to the sub-document.

For example, it is assumed that the specifying unit 604 specifies a policy that grants a specific reviser alone an authority of revision. At this time, even if the “nondisclosure” status is assigned to a sub-document by a reviser different from the specific reviser, the sub-document may be disclosed. As a result, revision that is beyond the authority of a reviser can be prevented.

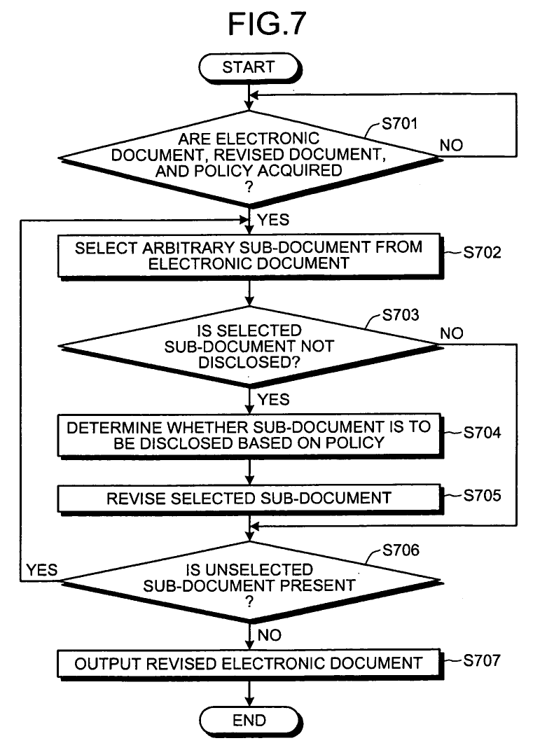

FIG. 7 is a flowchart of an example of an electronic document management processing procedure by the electronic document managing apparatus. As depicted in the flowchart of FIG. 7, a judgment is made upon whether the acquiring unit 601 acquires the electronic document M, revised documents R in which a sub-document of the electronic document M is given a nondisclosure status, and a policy that specifies disclosure/nondisclosure of each sub-document divided from the electronic document M (step S701).

The processing waits until the electronic document M, the revised documents R, and the policy are acquired (step S701: NO) and when acquired (step S701: YES), an arbitrary sub-document is selected from the electronic document M (step S702). The judging unit 602 judges whether a sub-document selected in each revised document R (hereinafter, “selected sub-document”) is in the nondisclosure status by making reference to the electronic document M (step S703).

When the selected sub-document is determined not to be disclosed in at least one revised document R (step S703: YES), the determining unit 603 determines whether the selected sub-document is to be disclosed (step S704). Based on a determination result from the determining unit 603, the revising unit 606 revises the selected sub-document in the electronic document M (step S705).

Thereafter, a judgment is made upon whether there still is an unselected sub-document in the electronic document M (step S706). When there is an unselected sub-document (step S706: YES), the processing returns to the step S702 to select the unselected sub-document from the electronic document M.

On the other hand, when there is no more an unselected sub-document (step S706: NO), the output unit 607 outputs the revised electronic document M revised by the revising unit 606 (step S707), thereby terminating the series of processing of the flowchart. When it is determined that the selected sub-document is in the disclosure status in all the revised documents R at the step S703 (step S703: NO), the processing advances to a step S706.

According to the embodiment explained above, the disclosure/nondisclosure status of each sub-document can be determined based on a policy given to each sub-document divided from the electronic document M. As a result, revision that is beyond authorities of revisers can be prevented, and an integrated document obtained by integrating the revised documents R revised in parallel by different revisers can be automatically created.

An example of the embodiment will now be explained. In the example, an electronic document managing apparatus 500 is, e.g., a computer device (e.g., an electronic document creating apparatus 801, an electronic document verifying apparatus 804, or client apparatuses 803-1 to 803-k) constituting an electronic document managing system, and an electronic document management program is a program installed in the electronic document managing apparatus 500. Like elements as the embodiment are denoted by like reference numerals, and an explanation thereof is omitted.

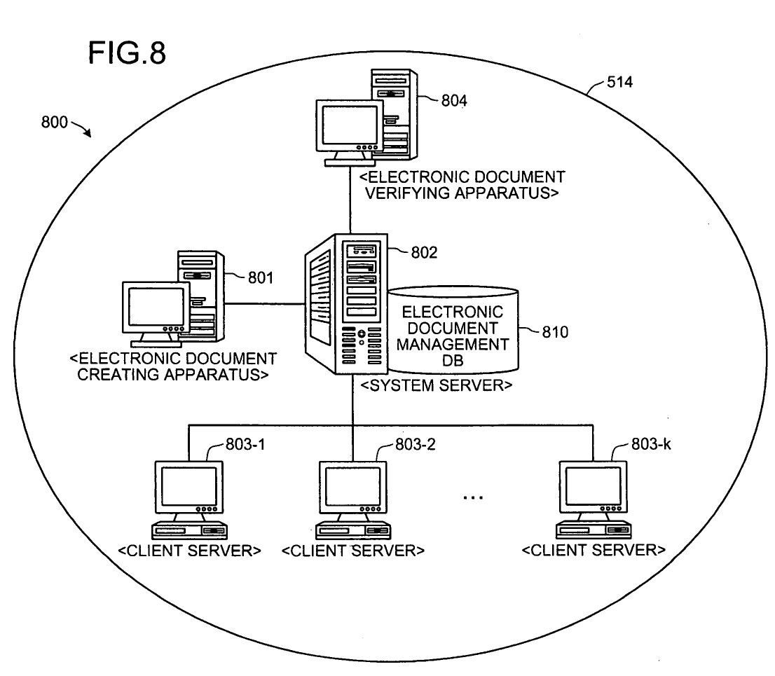

FIG. 8 is a block diagram of a system structure of the electronic document managing system. As depicted in FIG. 8, in the electronic document managing system 800, the electronic document creating apparatus 801, a system server 802, the client apparatuses 803-1 to 803-k, and the electronic document verifying apparatus 804 are connected with each other through a network 514 such as the Internet or a WAN to allow communication.

The electronic document creating apparatus 801 is a computer device having a function of creating an electronic document M. The electronic document creating apparatus 801 has a function of creating an electronic signature for the electronic document M and setting the electronic signature to the electronic document M. The electronic document M created by the electronic document creating apparatus 801 is stored in an electronic document management DB (database) 810 of the system server 802.

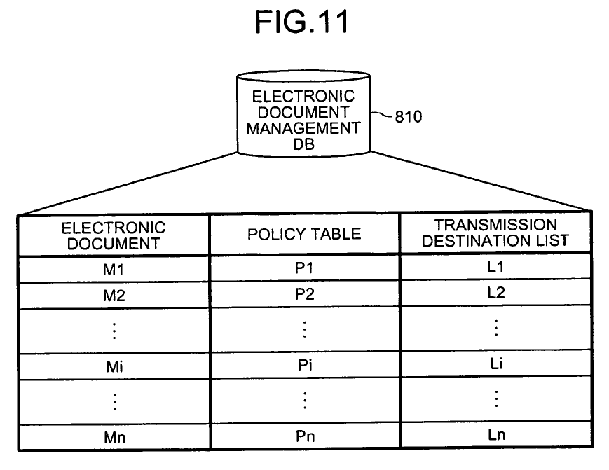

The electronic document creating apparatus 801 has a function of creating a policy that specifies a disclosure/nondisclosure status of each sub-document divided from the electronic document M. A list of the policies for the respective sub-documents is generated and stored in the electronic document management DB 810 (see FIG. 11 explained later) of the system server 802 in association with the electronic document M.

The system server 802 is a computer device that includes the electronic document management DB 810 and has a function of managing the electronic document M disclosed in the electronic document managing system 800. The system server 802 transmits the electronic document M in response to a transmission request from the electronic document verifying apparatus 804 and the client apparatuses 803-1 to 803-k. As the electronic document M is managed correlated with the client apparatuses 803-1 to 803-k, the client apparatuses 803-1 to 803-k, destination targets of the electronic document M, can be identified.

Each of the client apparatuses 803-1 to 803-k is a computer device having a function of revising an arbitrary sub-document in the electronic document M. The electronic document M can be acquired by issuing a transmission request to the system server 802. When revision of the electronic document M is finished, the revised electronic document M (revised document R) is transmitted to the system server 802.

As a result, in the system server 802, the electronic document M, the client apparatuses 803-1 to 803-k, and the revised document R are correlated and managed. Specifically, for example, the electronic document M, a document ID of the revised document R, and IP addresses of the client apparatuses 803-1 to 803-k may be correlated and managed. As a result, from among the client apparatuses 803-1 to 803-k as transmission destinations of the electronic document M, the client apparatus 803-1 to 803-k that have finished revision or have not finished revision can be recognized.

The electronic document verifying apparatus 804 is a computer device having a function of verifying authenticity of the revised document R created by the client apparatuses 803-1 to 803-k. The revised document R can be acquired by requesting transmission to the system server 802. The electronic document verifying apparatus 804 has a function of integrating the revised documents R created by the client apparatuses 803-1 to 803-k according to the policy of the electronic document M.

A timing of execution of electronic document management processing for integrating the revised documents R in the electronic document verifying apparatus 804 is arbitrary. In this embodiment, after all revised documents R created in the client apparatuses 803-1 to 803-k as transmission destinations of the electronic document M are acquired, the electronic document management processing is executed. Acquisition statuses of the revised documents R can be judged by making reference to a later-explained transmission destination list that can be obtained from the system server 802.

A flow of the electronic document management processing by the electronic document managing system 800 will now be explained with an example. A user (signatory) who utilizes the electronic document creating apparatus 801 first determines a user (reviser) who confirms contents of the electronic document M, and informs the client apparatuses 803-1 to 803-k utilized by this user of registration of the electronic document M.

The signatory further informs a user (integrator) utilizing the electronic document verifying apparatus 804 of who is the reviser receiving a request of confirmation of the electronic document M. The reviser confirms contents of the electronic document M, and revises a sub-document. The integrator waits until revision by all revisers finishes, and integrates revised documents R of all the revisers to create an integrated document.

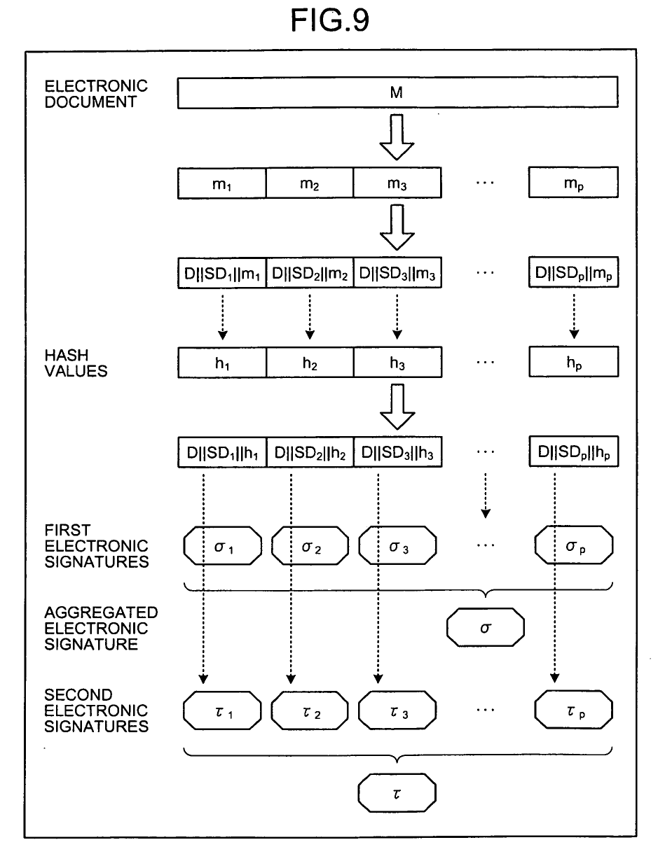

An outline of an electronic signature technology for guaranteeing authenticity of the electronic document M will now be explained. An electronic signature technology that is explained below is carried out for the electronic document M disclosed in the electronic document managing system 800. FIG. 9 is an explanatory diagram of an outline of the electronic signature technology. As depicted in FIG. 9, the electronic document M is first divided into p sub-documents m₁ to mₚ. Random numbers are utilized to add unpredictable document ID and sub-document IDs to the respective sub-documents m₁ to mₚ.

The document ID is a value that is common to all the sub-documents m₁ to mₚ divided from the electronic document M. The document ID added in common to the respective sub-documents m₁ to mₚ is represented as “D” hereinafter. The sub-document ID is a value that varies by the sub-documents m₁ to mₚ. The sub-document IDs are added to the respective sub-documents m₁ to mₚ in ascending order (or descending order) according to appearance positions of the respective sub-documents m₁ to mₚ in the electronic document M. The sub-document IDs added to the respective sub-documents m₁ to mₚ are represented as “SD₁, SD₂, . . . , SDₚ” hereinafter, respectively.

Each sub-document mⱼ having the document ID and the sub-document ID added thereto is represented as “D∥SDⱼ∥mⱼ” (j=1, 2, . . . , p) hereinafter. A hash value of the sub-document “D∥SDⱼ∥mⱼ” is calculated for each j. Hash values of the respective sub-documents “D∥SDⱼ∥mⱼ” are represented as “h₁, h₂, . . . , hₚ” hereinafter.

Subsequently, the document ID and the sub-document IDs corresponding to the respective hash values h₁ to hₚ are added. The hash values h₁ to hₚ having the document ID and the sub-document IDs added thereto are represented as “D∥SDⱼ∥hⱼ” (j=1, 2, . . . , p) hereinafter.

A first electronic signature for a hash value “D∥SDⱼ∥hⱼ” is generated by using a private key of a signatory for each j. The first electronic signatures with respect to the respective hash values “D∥SDⱼ∥hⱼ” are represented as “σ₁, σ₂, . . . , σₚ” hereinafter. After generation of the first electronic signatures σ₁ to σₚ, a first aggregated electronic signature σ obtained by aggregating these first electronic signatures σ₁ to σₚ is calculated. Specifically, the aggregated electronic signature σ may be calculated by multiplying the first electronic signatures σ₁ to σₚ.

The private key of the signatory is used to generate a second electronic signature with respect to the sub-document “D∥SDⱼ∥mⱼ” for each j. The second electronic signatures with respect to the respective sub-documents “D∥SDⱼ∥mⱼ” are represented as “τ₁, τ₂, . . . , τₚ” hereinafter. After generation of the second electronic signatures τ₁ to τₚ, a second aggregated electronic signature τ obtained by aggregating the second electronic signatures τ₁ to τₚ is calculated. Specifically, the second aggregated electronic signature τ may be calculated by multiplying the electronic signatures τ₁ to τₚ.

As schemes for generating the first and the second electronic signatures, an RSA signature scheme or an ESIGN signature based on factorization into prime numbers, an ElGamal signature or a DSA signature based on a discrete logarithm, or an elliptic ElGamal signature or an elliptic DSA signature based on an elliptic discrete logarithm can be used, for example. The first and the second electronic signatures are different electronic signatures generated by using different algorithms.

The first electronic signatures σ₁ to σₚ and the second electronic signatures τ₁ to τₚ are set in the corresponding sub-documents “D∥SDⱼ∥mⱼ”. The first aggregated electronic signature σ obtained by aggregating the first electronic signatures σ₁ to σₚ and the second aggregated electronic signature τ obtained by aggregating the second electronic signatures τ₁ to τₚ are set in the electronic document M.

By setting the first electronic signatures σ₁ to σₚ and the second electronic signatures τ₁ to τₚ in each sub-document “D∥SDⱼ∥mⱼ” and setting the aggregated electronic signatures σ and τ in the electronic document M in this manner, authenticity of the revised electronic document M (revised document R) can be verified even if sub-documents “D∥SDⱼ∥mⱼ” are revised.

Specifically, even if revision such as shuffling or copying of sub-documents m₁ to mₚ in the electronic document M is carried out, authenticity of the electronic document M after revision can be verified from the document ID or the sub-document IDs given to the respective sub-documents m₁ to mₚ.

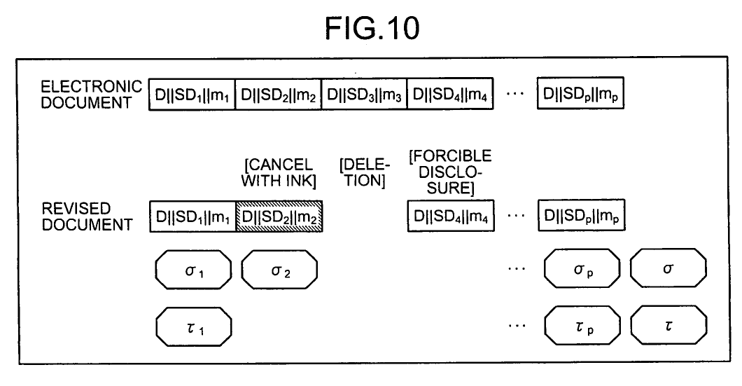

A specific example of revision processing for revising the electronic document M subjected to the electronic signature technology will now be explained. FIG. 10 is an explanatory diagram of an outline of the revision processing. In this example, the revision processing for revising each sub-document will be explained in the order of “blacking-out”, “deletion”, and “compulsory disclosure”.

First, a sub-document as a target of blacking-out is specified from the sub-documents m₁ to mₚ divided from the electronic document M. The sub-document m₂ is specified as the target of blacking-out in this example. One of a first electronic signature σ₂ and a second electronic signature τ₂ set in the sub-document m₂ is deleted. In this example, the second electronic signature τ₂ is deleted.

When the second electronic signature τ₂ set in the sub-document m₂ is deleted, the sub-document m₂ is replaced with a hash value h₂ of the sub-document m₂. After replacement of the sub-document m₂ with the hash value h₂ is completed, “D∥SDⱼ∥h₂” is blacked out and the sub-document m₂ is eventually hidden.

A sub-document as a deletion target is specified from the sub-documents m₁ to mₚ divided from the electronic document M. A sub-document m₃ is specified as the deletion target in this example. A first electronic signature σ₃ and a second electronic signature τ₃ set in the sub-document m₃ are deleted.

The first electronic signature σ₃ and the second electronic signature τ₃ set in the sub-document m₃ are deleted from a first aggregated electronic signature σ and a second aggregated electronic signature τ set in the electronic document M. The sub-document m₃ specified as the deletion target is deleted.

Subsequently, a sub-document as a compulsory disclosure target is specified from the sub-documents m₁ to mₚ divided from the electronic document M. A sub-document m₄ is specified as the compulsory disclosure target in this example. A first electronic signature σ₄ and a second electronic signature τ₄ set in the sub-document m₄ are deleted.

Performing the revision processing to the respective sub-documents m₁ to mₚ based on such a scheme enables setting attributes (blacking-out, deletion, and compulsory disclosure) of the sub-documents m₁ to mₚ to be unchangeable at subsequent steps and uniquely specifying attributes of the revised sub-documents m₁ to mₚ.

Since the first electronic signatures σ₁ to σₚ and the second electronic signatures τ₁ to τₚ are calculated based on the sub-document IDs given to the respective sub-documents m₁ to mₚ order information of the sub-documents m₁ to mₚ having attributes such as “blacking-out”, “deletion”, or “compulsory disclosure” can be maintained even after the revision. Therefore, even if the revision such as “blacking-out”, “deletion”, or “compulsory disclosure” is carried out, authenticity of the revised document R can be verified.

FIG. 11 is an explanatory diagram of contents of the electronic document management DB. As depicted in FIG. 11, the electronic document DB 810 stores policy tables P1 to Pn for specifying a disclosure/nondisclosure status of sub-documents divided from electronic documents M1 to Mn, and transmission destination lists L1 to Ln for managing revision statuses of the client apparatuses 803-1 to 803-k as transmission destinations.

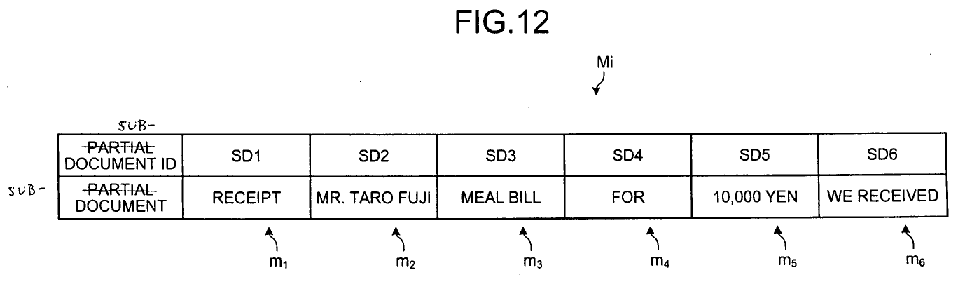

An electronic document Mi will be taken as an example to explain a policy table Pi and a transmission destination list Li. The electronic document Mi will be first explained. FIG. 12 is an explanatory diagram of a specific example of an electronic document. As depicted in FIG. 12, the electronic document Mi is divided into a plurality of sub-documents m₁ to m₆.

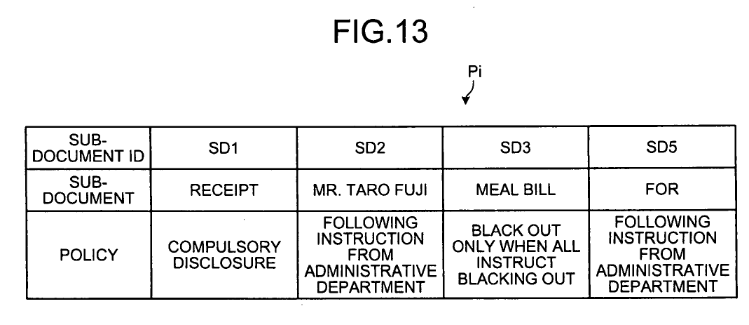

FIG. 13 is an explanatory diagram of a specific example of a policy table. As depicted in FIG. 13, in the policy table Pi, policies for specifying a disclosure/nondisclosure status of the sub-documents m₁, m₂, m₃, and m₅ divided from the electronic document Mi are specified.

Specifically, as a policy of the sub-document m₁ “RECEIPT” having a sub-document ID “SD1”, “compulsory disclosure” is specified. As a policy of the sub-document m₂ “MR. TARO FUJI” having a sub-document ID “SD2”, “FOLLOWING INSTRUCTION FROM ADMINISTRATIVE DEPARTMENT” is specified. As a policy of the sub-document m₃ “MEAL BILL” having a sub-document ID “SD3”, “BLACK OUT ONLY WHEN ALL INSTRUCT BLACKING OUT” is specified. As a policy of the sub-document m₅ “10,000 YEN” having a sub-document ID “SD5”, “FOLLOWING INSTRUCTION FROM ACCOUNTING DEPARTMENT” is specified.

Policies are not specified for the sub-documents m₄ and m₆. In such a case, a disclosure/nondisclosure status is determined so as to leave the sub-documents m₄ and m₆ as far as possible. For example, regarding the sub-document m₄ “FOR”, when a certain reviser specifies “deletion” whilst another reviser specifies “blacking-out”, “blacking-out” that can leave a vestige of the sub-document m₄ as much as possible is selected.

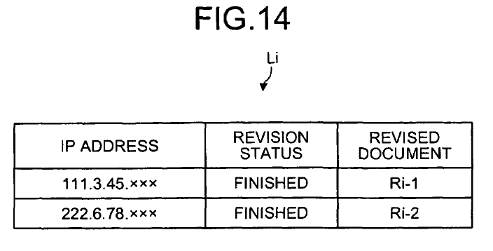

The transmission destination list Li of the electronic document Mi will now be explained. FIG. 14 is an explanatory diagram of a specific example of a transmission destination list. As depicted in FIG. 14, the transmission destination list Li includes an IP address, a revision status, and a revised document for each of the client apparatuses 803-1 to 803-k as the transmission destination of the electronic document Mi.

The revision status is information that specifies whether revision of the electronic document Mi is completed in each of the client apparatuses 803-1 to 803-k. “NOT FINISHED” is written when the electronic document Mi is transmitted to the client apparatuses 803-1 to 803-k, and “FINISHED” is written when the revised electronic document Mi is received from the client apparatuses 803-1 to 803-k.

The revised document is the revised electronic document Mi (revised document Ri-1 or Ri-2) revised in the client apparatuses 803-1 to 803-k. The transmission destination list Li is transmitted from the system server 802 to the electronic document verifying apparatus 804 in response to a transmission request from the electronic document verifying apparatus 804. As a result, acquisition statuses of the revised documents Ri-1 and Ri-2 can be recognized in the electronic document verifying apparatus 804.

An outline of electronic document management processing in the example is explained with reference to a case where the administrative department and the accounting department in FIG. 4 perform revision of an electronic document 101 in parallel. The electronic document management processing is executed in the electronic document verifying apparatus 804 in this example. The electronic document 101 depicted in FIG. 4 is represented as “electronic document Mi”; the revised document 301, “revised document Ri-1”; the revised document 302, “revised document Ri-2”; and the revised document 401, “an integrated document U” hereinafter.

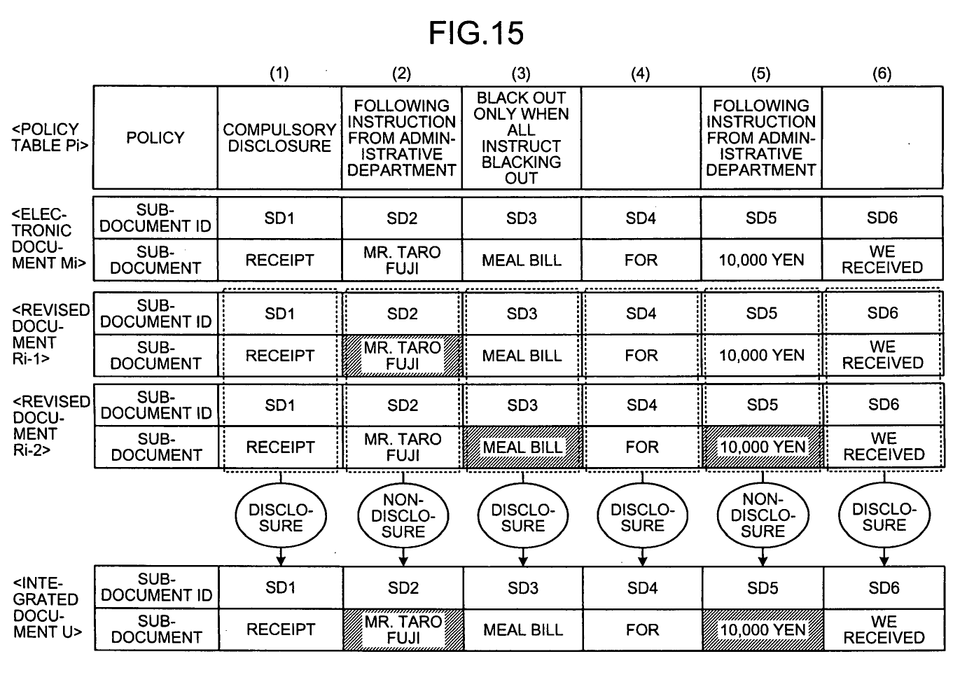

FIG. 15 is an explanatory diagram of an outline of electronic document management processing in the electronic document verifying apparatus 804. As depicted in FIG. 15, (1) the specifying unit 604 first makes reference to the policy table Pi to specify specification contents “COMPULSORY DISCLOSURE” of a sub-document “RECEIPT” having a sub-document ID “SD1”, and the determining unit 603 determines to disclose the sub-document “RECEIPT”.

Next, (2) the specifying unit 604 specifies specification contents “FOLLOWING INSTRUCTION FROM ADMINISTRATIVE DEPARTMENT” in a sub-document “MR. TARO FUJI” having a sub-document ID “SD2”. The judging unit 602 makes reference to the electronic document Mi to judge whether the sub-document “MR. TARO FUJI” having the sub-document ID “SD2” is not disclosed in the revised documents Ri-1 and Ri-2.

The sub-document is not disclosed in the revised document Ri-1 in this example. The detecting unit 605 detects nondisclosure of the sub-document “MR. TARO FUJI” in the revised document Ri-1 of the “administrative department”, and the determining unit 603 determines not to disclose the sub-document “MR. TARO FUJI”.

Then, (3) the specifying unit 604 specifies specification contents “BLACK OUT ONLY WHEN ALL INSTRUCT BLACKING OUT” of a sub-document “MEAL BILL” having a sub-document ID “SD3”. This means that blacking-out is carried out when apercentage of revised documents having a non-disclosed sub-document in all revised documents is 100%.

Subsequently, the judging unit 602 makes reference to the electronic document Mi to judge whether the sub-document “MEAL BILL” having the sub-document ID “SD3” is in the nondisclosure status in the revised documents Ri-1 and Ri-2. The revised documents Ri-2 gives the nondisclosure status in this example.

The detecting unit 605 detects a percentage “½=50%” of the revised document Ri-2 having the non-disclosed sub-document “MEAL BILL” among the revised documents Ri-1 and Ri-2, and the determining unit 603 determines to disclose the sub-document “MEAL BILL” since the percentage of nondisclosure is yet to reach “100%”.

Then, (4) the specifying unit 604 specifies specification contents of a sub-document “FOR” having a sub-document ID “SD4”. A policy of the sub-document “FOR” is not specified in this example. Therefore, the determining unit 603 determines to disclose the sub-document “FOR”.

Subsequently, (5) the specifying unit 604 specifies specification contents “FOLLOWING INSTRUCTION FROM ACCOUNTING DEPARTMENT” of a sub-document “10,000 YEN” having a sub-document ID “SD5”. The judging unit 602 judges whether the sub-document “10,000 YEN” having the sub-document ID “SD5” is not disclosed in the revised documents Ri-1 and Ri-2.

The sub-document is not disclosed in the revised document Ri-2 in this example. The detecting unit 605 detects nondisclosure of the sub-document “10,000 YEN” in the revised document Ri-2 of the “accounting department”, and the determining unit 603 determines not to disclose the sub-document “10,000 YEN”.

At last, (6) the specifying unit 604 specifies specification contents of a sub-document “WE RECEIVED” having a sub-document ID “SD6”. A policy of the sub-document “WE RECEIVED” is not specified in this example. Therefore, the determining unit 603 determines to disclose the sub-document “WE RECEIVED”.

The revising unit 606 revises the sub-documents in the electronic document Mi to create an integrated document U according to the disclosure/nondisclosure status of the respective sub-documents determined as explained above. In this example, the sub-documents “MR. TARO FUJI” and “10,000 YEN” in the electronic document Mi are blacked out to create the integrated document U that is not to be disclosed.

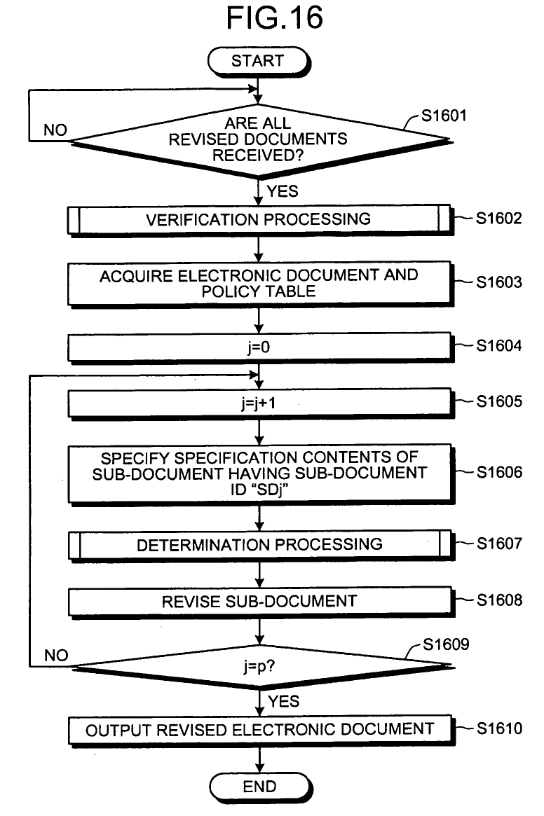

FIG. 16 is a flowchart of an electronic document management processing procedure of the electronic document verifying apparatus 804. As depicted in the flowchart of FIG. 16, the acquiring unit 601 first judges whether all revised documents R of the electronic document M revised by a plurality of revisers are acquired (step S1601).

The processing waits until all the revised documents R are acquired (step S1601: NO), and when all the revised documents R are acquired (step S1601: YES), verification processing of verifying authenticity of the revised documents R is executed (step S1602). After authenticity of all the revised documents R is verified, the acquiring unit 601 acquires the electronic document M and a policy table P (step S1603), and initializes “j” (j=0), j representing a sub-document ID of each sub-document in the electronic document M (step S1604).

Thereafter, “j” is incremented by “1” (step S1605), and the specifying unit 604 makes reference to the policy table P to specify specification contents of a sub-document having a sub-document ID “SDj” (step S1606) and executes determination processing of determining whether the sub-document having the sub-document ID “SDj” is to be disclosed (step S1607).

The revising unit 606 revises the sub-document having the sub-document ID “SDj” based on a determination result obtained by the determining unit 603 (step S1608) and judges whether “j=p” (step S1609). However, “p” represents the number of the sub-documents divided from the electronic document M.

If “j<p” (step S1609: NO), the processing returns to the step S1605 to increment “j” by “1”. If “j=p” (step S1609: YES), the output unit 607 outputs the revised electronic document M (step S1610) to terminate the series of processing based on the flowchart.

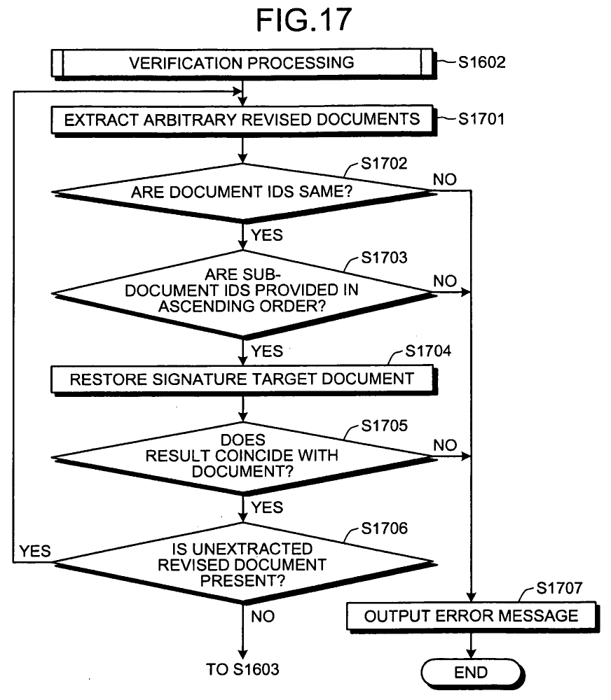

A specific processing procedure of verification processing at the step S1602 depicted in FIG. 16 will now be explained. The electronic document verifying apparatus 804 causes the CPU 501 to execute a verification program stored in the storage region to realize the verification processing for verifying authenticity of the revised document R. FIG. 17 is a flowchart of a specific processing procedure of the verification processing.

As depicted in the flowchart in FIG. 17, an arbitrary revised document R is first extracted from the revised documents R acquired at the step S1601 in FIG. 16 (step S1701). It is determined whether the documents IDs given to respective sub-documents in the extracted revised document are identical (step S1702).

If the document IDs are identical (step S1702: YES), it is determined whether sub-document IDs given to the respective sub-documents in the revised document R are provided in ascending order (step S1703).

If the sub-document IDs are provided in ascending order (step S1703: YES), a signature target document is restored by calculating hash values of the respective sub-documents in the revised document R (step S1704). Since a blacked-out sub-document is replaced with the hash value of the sub-document, the hash value is not needed.

An aggregated electronic signature σ set in the revised document R is decrypted and it is determined whether a decoding result of the aggregated electronic signature σ matches the signature target document (step S1705). If they match each other (step S1705: YES), it is determined whether there is still a revised document R not yet extracted (step S1706).

If there is still a revised document R not yet extracted (step S1706: YES), the processing returns to the step S1701 to extract the not-yet-extracted revised document R from the revised documents R. If there is no more not-yet-extracted revised document R any more (step S1706: NO), the processing advances to the step S1603 depicted in FIG. 16.

If the document IDs are not all identical at the step S1702 (step S1702: NO), an error message indicating that fraudulent alteration exists is output (step S1707), and the series of processing is terminated.

If the sub-document IDs are not provided in ascending order at the step S1703 (step S1703: NO), an error message is output (step S1707) to terminate the series of processing. If no match is observed at the step S1705 (step S1705: NO), an error message is output (step S1707) to terminate the series of processing.

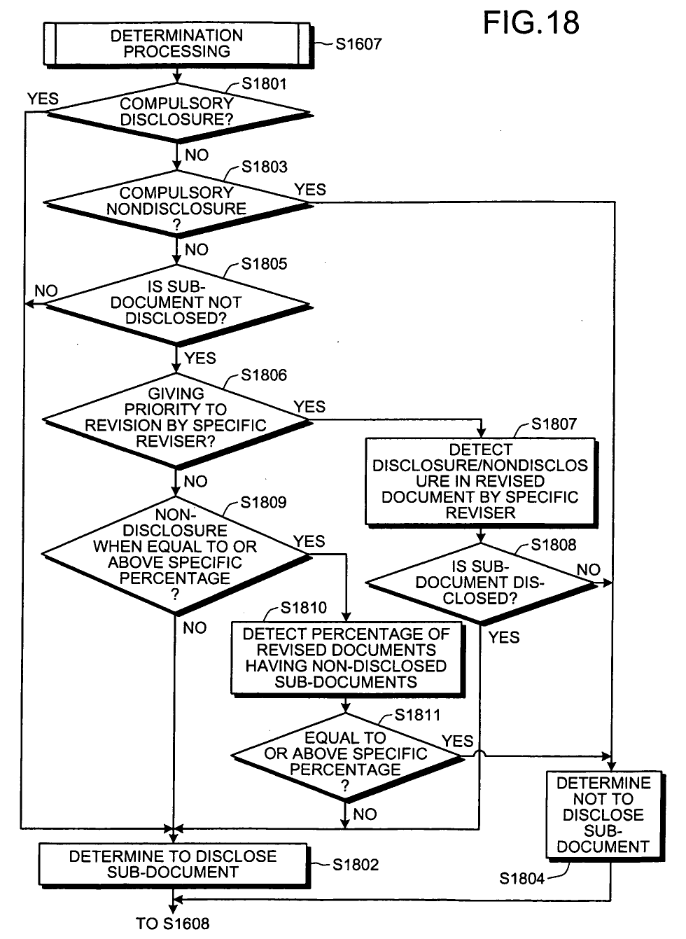

A specific processing procedure of determination processing at the step S1607 depicted in FIG. 16 will now be explained. FIG. 18 is a flowchart of a specific processing procedure of the determination processing. As depicted in the flowchart in FIG. 18, the determining unit 603 first judges whether specification contents specified at the step S1606 in FIG. 16 correspond to “compulsory disclosure” (step S1801).

If the contents are “compulsory disclosure” (step S1801: YES), disclosure of a sub-document having a sub-document ID “SDj” is determined (step S1802), and the processing advances to the step S1608 depicted in FIG. 16. If it is determined that the contents are not “forcible disclosure” (step S1801: NO), it is determined whether the specification contents are “compulsory nondisclosure” (step S1803).

If it is determined that the contents are “compulsory nondisclosure” (step S1803: YES), the sub-document having the sub-document ID “SDj” is determined not to be disclosed (step S1804), and the processing proceeds to the step S1608 depicted in FIG. 16. If it is determined that the specification contents are not “compulsory nondisclosure” (step S1803: NO), the judging unit 602 judges whether the sub-document having the sub-document ID “SDj” is in the nondisclosure status in each revised document R (step S1805).

If the sub-document having the sub-document ID “SDj” is disclosed in each revised document R (step S1805: NO), the determining unit 603 determines to disclose the sub-document having the sub-document ID “SDj” (step S1802). If the sub-document having the sub-document ID “SDj” is not disclosed in at least one revised document R (step S1805: YES), it is determined whether specification contents are “giving priority to revision by a specific reviser” (step S1806).

If it is determined that the contents are “giving priority to revision by a specific reviser” (step S1806: YES), the detecting unit 605 detects the disclosure/nondisclosure status of the sub-document having the sub-document ID “SDj” in a revised document R obtained by a specific reviser (step S1807) to judge whether the sub-document having the sub-document ID “SDj” is in the disclosure status (step S1808).

If the sub-document having the sub-document ID “SDj” is in the disclosure status (step S1808: YES), the determining unit 603 decides to disclose the sub-document having the sub-document ID “SDj” (step S1802). If the sub-document is in the nondisclosure status (step S1808: NO), the determining unit 603 decides not to disclose the sub-document having the sub-document ID “SDj” (step S1804).

If it is determined that “giving priority to revision by a specific reviser” is not the specification contents at the step S1806 (step S1806: NO), it is determined whether the specification contents are “nondisclosure when at least equal to a specific percentage” (step S1809).

If it is determined that the specification contents are “nondisclosure when at least equal to a specific percentage (step S1809: YES), the detecting unit 605 detects a percentage of revised documents R having a sub-document with the sub-document ID “SDj” being set to nondisclosure (step S1810) to judge whether the detected percentage is at least equal to a specific percentage (step S1811).

When the detected percentage is at least equal to the specific percentage (step S1811: YES), the determining unit 603 determines not to disclose the sub-document having the sub-document ID (SDj) (step S1804). If the detected percentage is less than the specific percentage (step S1811: NO), the determining unit 603 decides to disclose the sub-document having the sub-document ID “SDj” (step S1802). If it is determined that “nondisclosure when at least equal to a specific percentage” is not the specification contents at the step S1809 (step S1809: NO), the determining unit 603 decides to disclose the sub-document having the sub-document ID “SDj” (step S1802).

According to the example, carrying out the electronic signature technology to the electronic document Mi enables guaranteeing integrity of disclosed sub-documents in the revised documents Ri-1 and Ri-2. It is possible to automatically create the integrated document U obtained by integrating the revised documents Ri-1 and Ri-2 subjected to revision processing by different revisers (administrative department, accounting department) in parallel according to the policy table Pi.

As a result, an integrator's complicated operation, i.e., checking the respective revised documents Ri-1 and Ri-2 with authorities of respective revisers to judge whether revision beyond authority is carried out or judging which reviser should have priority of revision, is no longer necessary, thereby reducing a work burden on an integrating operation for the revised documents Ri-1 and Ri-2.

The method explained in the present embodiments can be implemented by a computer, such as a personal computer and a workstation, executing a program that is prepared in advance. The program is recorded on a computer-readable recording medium such as a hard disk, a flexible disk, a CD-ROM, an MO, and a DVD, and is executed by being read out from the recording medium by a computer. The program can be a transmission medium that can be distributed through a network such as the Internet.

As set forth above, according to the exemplary embodiments, revision beyond authority of a reviser can be prevented and an integrated document obtained by appropriately integrating a plurality of revised documents subjected to revision processing by different revisers in parallel can be automatically created.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present inventions have been described in detail, it should be understood that the various changes, substitutions, and alterations could be made hereto without departing from the spirit and scope of the invention.

What is claimed is:

1. A computer-readable recording medium storing an electronic document management program causing a computer to perform:
storing a policy that specifies a disclosure/nondisclosure status of a constituent element divided from an electronic document;
acquiring the electronic document and a plurality of revised documents subjected to revision processing of determining nondisclosure of the constituent element in the electronic document concerning each of different revisers;
judging, referring to the electronic document, whether the constituent element is not disclosed in each revised document according to the constituent element in the electronic document;
determining whether the constituent element is to be disclosed based on the policy when the constituent element is determined not to be disclosed in at least one revised document;
revising the constituent element in the electronic document based on a result of the determining; and
outputting the revised electronic document.

2. The computer-readable recording medium according to claim 1, the program further causing the computer to perform
specifying specification contents of the constituent element in the policy, wherein
at the determining, the constituent element is determined to be disclosed when compulsory disclosure of the constituent element is specified at the specifying.

3. The computer-readable recording medium according to claim 2, wherein
at the determining, the constituent element is determined not to be disclosed when compulsory nondisclosure of the constituent element is specified at the specifying.

4. The computer-readable recording medium according to claim 2, the program further causing the computer to perform
detecting a disclosure/nondisclosure status of the constituent element in a revised document by a specific reviser from the revised documents when the constituent element is determined not to be disclosed at the judging and specification contents of giving priority to revision by the specific reviser is specified at the specifying, wherein
at the determining, it is determined whether the constituent element is to be disclosed based on the disclosure/nondisclosure status of the constituent element in the revised document by the specific reviser.

5. The computer-readable recording medium according to claim 2, wherein
at the detecting, a percentage of revised documents having the constituent element determined not to be disclosed is detected when at the judging, the nondisclosure of the constituent element is determined and at the specifying, specification contents are specified to be determining nondisclosure of the constituent element when a percentage of revisers performing revision processing of determining nondisclosure of the constituent element is at least equal to a specific percentage, and
nondisclosure of the constituent element is determined when the percentage is at least equal to the specific percentage.

6. The computer-readable recording medium according to claim 1, wherein
at the acquiring, the electronic document and a revised document subjected to revision processing concerning a first reviser for determining nondisclosure of an arbitrary constituent element in the electronic document and subjected to revision processing concerning a second reviser for determining nondisclosure of an arbitrary constituent element in the electronic document after the revision processing concerning the first reviser are acquired,
at the judging, the electronic document is referred to in order to judge whether the constituent element is not disclosed in the revised document, and
at the determining, it is determined whether the constituent element is to be disclosed according to each constituent element based on the first or the second reviser performing the revision processing of determining nondisclosure of the constituent element and the policy when nondisclosure of the constituent element is determined at the judging.

7. The computer-readable recording medium according to claim 1, the program further causing a computer to perform:
assigning a random number that is an authentic random number or a pseudo random number to each constituent element divided from the electronic document in an order of each appearance position in the electronic document; and
deciding whether the random number conforms to the order of the appearance position of each constituent element in the electronic document, wherein
at the judging, it is judged whether the constituent element is not disclosed in the revised document according to each constituent element in the electronic document when at the deciding, it is decided that each random number conforms to the order of the appearance position of each constituent element.

8. The computer-readable recording medium according to claim 7, the program further causing the computer to perform
assigning a common random number that is an authentic random number or a pseudo random number common to the constituent elements to each constituent element divided from the electronic document, wherein
at the deciding, it is decided whether the common random number assigned to each constituent element in the revised document is common, and
at the judging, it is judged whether the constituent element is not disclosed in the revised document according to each constituent element in the electronic document when at the deciding, it is decided that the common random number assigned to each constituent element is common.

9. The computer-readable recording medium according to claim 7, the program further causing the computer to perform
setting an electronic signature generated according to each constituent element to each constituent element divided from the electronic document, wherein
at the deciding, validity of each constituent element is decided based on the electronic signature set to each constituent element in the revised document, and
at the judging, it is judged whether the constituent element is not disclosed in the revised document according to each constituent element in the electronic document when at the deciding, it is decided that each constituent element is valid.

10. The computer-readable recording medium according to claim 7, the program further causing the computer to perform
setting to the electronic document an aggregated electronic signature obtained by aggregating electronic signatures generated for respective constituent elements divided from the electronic document,
at the deciding, validity of the revised document is decided based on the aggregated electronic document set to the electronic document, and
it is judged whether the constituent element is not disclosed in the revised document according to each constituent element when at the deciding, it is decided that the revised document is valid.

11. An electronic document management apparatus comprising:
a storing unit that stores a policy that specifies a disclosure/nondisclosure status of a constituent element divided from an electronic document;
an acquiring unit that acquires the electronic document and a plurality of revised documents subjected to revision processing of determining nondisclosure of the constituent element in the electronic document concerning each of different revisers;
a judging unit that judges, referring to the electronic document, whether the constituent element is not disclosed in each revised document according to the constituent element in the electronic document;
a determining unit that determines whether the constituent element is to be disclosed based on the policy when the constituent element is determined not to be disclosed in at least one revised document;
a revising unit that revises the constituent element in the electronic document based on a result of the determining unit; and
an outputting unit that outputs the revised electronic document.

12. An electronic document management method comprising:
storing a policy that specifies a disclosure/nondisclosure status of a constituent element divided from an electronic document;
acquiring the electronic document and a plurality of revised documents subjected to revision processing of determining nondisclosure of the constituent element in the electronic document concerning each of different revisers;
judging, referring to the electronic document, whether the constituent element is not disclosed in each revised document according to the constituent element in the electronic document;
determining whether the constituent element is to be disclosed based on the policy when the constituent element is determined not to be disclosed in at least one revised document;
revising the constituent element in the electronic document based on a result of the determining; and
outputting the revised electronic document.
